(19) United States
(12) Patent Application Publication
(10) Pub. No.: US 2008/0209053 A1
(43) Pub. Date: Aug. 28, 2008

(54) HTTP-Based Peer-to-Peer Framework

(75) Inventors: Guobin Shen, Beijing (CN); Yongqiang Xiong, Beijing (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/680,373

(22) Filed: Feb. 28, 2007

(51) Int. Cl. G06F 15/16

(52) U.S. Cl. 709/228

(57) ABSTRACT

An HTTP-based P2P framework is described. In one implementation, an exemplary system reduces network congestion caused by P2P traffic at Internet Service Providers (ISPs) by packetizing P2P data and recruiting pre-existing Internet web caches (for HTTP traffic) to cache the P2P traffic. Exemplary pinging techniques detect the web caches, which are usually transparent, and determine their usability. Then, an exemplary topology-building protocol constructs a cache-aware tree-structured P2P overlay that prefers to deliver the P2P traffic via cached data paths. The cache-aware tree-structured P2P overlay has a logical structure that maximizes P2P data transit over paths that have pre-existing Internet web caches. If no web caches are detected, then peers are put into an orphan set and can resort to conventional P2P technology.

### BACKGROUND

As shown in FIG. 1, the popularity of peer-to-peer (P2P) applications on the Internet 100 has resulted in traffic bottlenecks and severe tension between Internet Service Providers (ISPs) 102 and P2P services, especially when many peers 104 are active. While P2P applications generally eliminate the problems of “flash crowd” and “server overload” that afflict servers in traditional client-server systems, emergence of P2P streaming applications such as P2P IPTV (peer-to-peer Internet TV) has created other problems—such as data surges and network congestion 106 for the ISPs 102. P2P data is typically not segmented or formatted in a manner that would allow the pre-existing web caches 108 to handle the P2P traffic. ISPs themselves report that P2P traffic accounts for a major portion of the Internet 100, surpassing any other application category, and is bound to increase even further. The network congestion 106 caused by P2P traffic not only affects P2P users, but also affects non-P2P users as the net bandwidth is shifted to the P2P traffic. Further, it is reckoned that more than 92% of the P2P traffic traverses transit/peering links among ISPs, thereby affecting the monetary bottom line of the ISPs 102. The overwhelming bandwidth consumption of P2P systems—despite their inherently scalable design—may also prevent them from scaling further, at least within certain business and academic environments.

The traffic overload and financial burden incurred by P2P applications on ISP networks has prompted many ISPs 102 to block or rate-limit the P2P traffic. Such reactionary measures annoy users who may take their business to other providers. A more constructive approach attempts to deploy new P2P-specific cache proxies to cache the P2P traffic, similar to the existing web caching. Unfortunately, the obstacles for deploying new P2P caches are significant. First, caching systems specifically designed for P2P traffic are very complicated. Unlike standard IP web traffic that is standardized to use hypertext transfer protocol (HTTP) through a few dedicated ports (such as port 80) there is as yet no standard P2P protocol, and so each P2P protocol uses its own port. As a result, P2P caching systems are forced to take an ad hoc approach that includes enumerating and handling multiple P2P protocols. Yet, such a caching system might be possible in the future, since currently there are only a few popular P2P systems that contribute most of the traffic.

Another drawback of such a potential ad hoc approach is a requirement to regularly update P2P cache engines to handle each new P2P protocol that emerges. Extra investment-possibly a huge monetary outlay—would be required for the hardware, facilities, and administrative cost to implement such a caching system that is exclusively directed to conventional P2P data traffic.

Yet, in related studies, P2P traffic of a small ISP 102 has been found to be highly repetitive, showing great potential for caching. Analysis has revealed that the outbound hit rate could potentially reach approximately 85%, and the inbound hit rate could reach up to 35% even when the cache 108 has not fully warmed. For example, significant locality in the KAZAA P2P workload has been identified, which implies a 63% cache hit rate reckoned by conservative trace driven estimation. P2P systems typically exhibit good stability and persistence at the prefix and AS aggregation levels. For example, besides data messages, query messages in GNUTELLA networks have been found to exhibit temporal locality and therefore lend themselves to caching.

The problem with these conventional solutions for network overload caused by P2P congestion is that they require a staggering investment in new, P2P-specific caches. What is needed is a solution that makes use of web caches 108 already in place on the Internet 100.

### SUMMARY

An HTTP-based P2P framework is described. In one implementation, an exemplary system reduces network congestion caused by P2P traffic at Internet Service Providers (ISPs) by packetizing P2P data and recruiting pre-existing Internet web caches (for HTTP traffic) to cache the P2P traffic. Exemplary pinging techniques detect the web caches, which are usually transparent, and determine their usability. Then, an exemplary topology-building protocol constructs a cache-aware tree-structured P2P overlay that prefers to deliver the P2P traffic via cached data paths. The cache-aware tree-structured P2P overlay has a logical structure that maximizes P2P data transit over paths that have pre-existing Internet web caches. If no web caches are detected, then peers are put into an orphan set and can resort to conventional P2P technology.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagram of conventional congestion at an Internet Service Provider (ISP) caused by conventional peer-to-peer (P2P) data traffic.

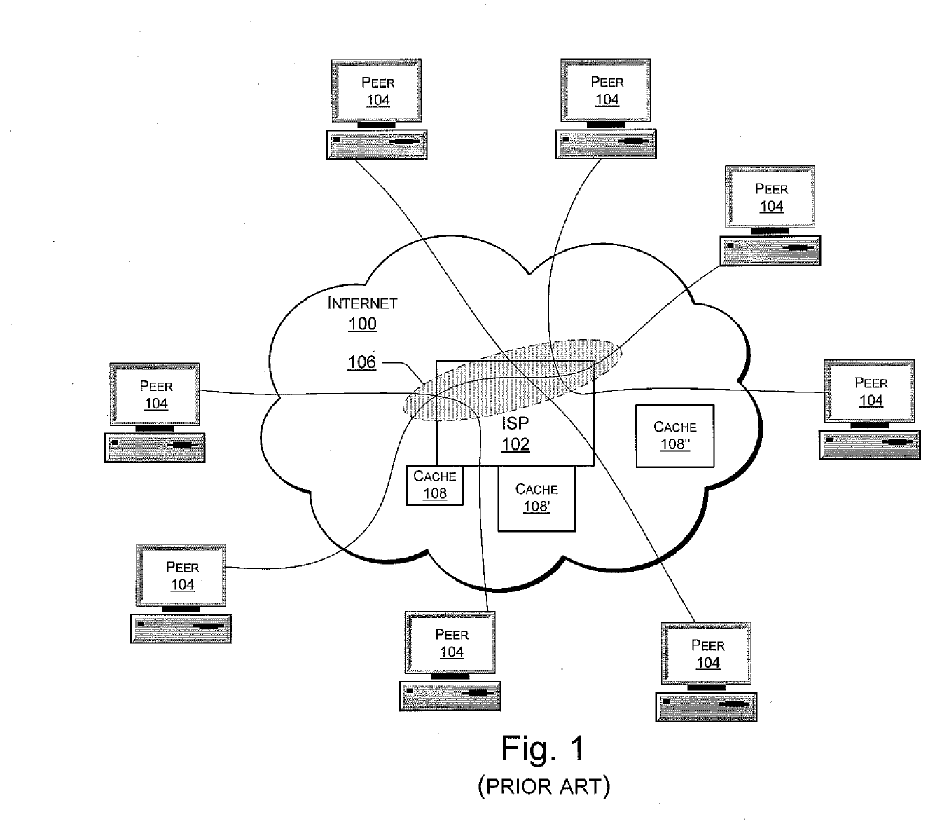

FIG. 2 is a block diagram of an exemplary “HTTP-based P2P” (HPTP) framework.

FIG. 3 is a diagram of P2P data packetization.

FIG. 4 is a flow diagram of exemplary pinging for web cache detection and cache usability evaluation.

FIG. 5 is a flow diagram of an exemplary method of pinging to evaluate cache usability, showing a process by which a second peer responds to an exemplary ping received from a first peer.

FIG. 6 is a diagram of an exemplary cache-aware tree-structured P2P overlay.

FIG. 7 is a diagram of an exemplary P2P communication layout as enabled by the exemplary cache-aware tree-structured P2P overlay of FIG. 6.

FIG. 8 is a flow diagram of an exemplary method of reducing peer-to-peer (P2P) congestion for Internet Service Providers.

### DETAILED DESCRIPTION

Overview

Described herein are systems and methods that provide an HTTP-based Peer-to-Peer (P2P) framework referred to herein as “HPTP.” The exemplary HPTP framework packetizes P2P data to take advantage of pre-existing web cache proxies (“caches”) on the Internet in order to reduce the P2P traffic by caching repetitively requested data. In doing so, the exemplary HPTP framework relieves Internet Service Providers (ISPs) from much congestion caused by conventional P2P traffic.

In one implementation, the HPTP framework applies an exemplary “HTTP-ifying” process to packetize the P2P traffic so that pre-existing widely deployed web caches of ISPs will accept and cache the P2P traffic. An exemplary HTTP-ifier segments large P2P files or streams into smaller chunks (if necessary), encapsulates and transports them using known HTTP protocol so that they are cacheable when they encounter the pre-existing caches on the web.

Besides HTTP-ifying P2P data, the exemplary HPTP framework also includes cache discovery and cache usability testing. Since the pre-existing web caches are invisible to a sending peer whose message arrives at a receiving peer, an exemplary pinger implements IP address reflection to perform the subtle task of detecting transparent web caches.

To combine these components of the exemplary HPTP framework into a coherent and powerful traffic overload reduction system, an exemplary cache-aware tree construction (CATC) protocol creates a cache-aware tree-structured P2P overlay for delivering P2P streaming traffic such that cache hits are maximized. The cache-aware delivery tree is constructed to capitalize on the presence of web caches detected by the exemplary pinger In one implementation, each node in the P2P overlay tree sends requests only to its parent node in the tree.

Simulation results demonstrate that the exemplary HPTP framework leads to significant performance improvement for ISPs and for both P2P users and non-P2P users, by significantly reducing network overload caused by repetitive P2P traffic.

Exemplary HPTP Framework

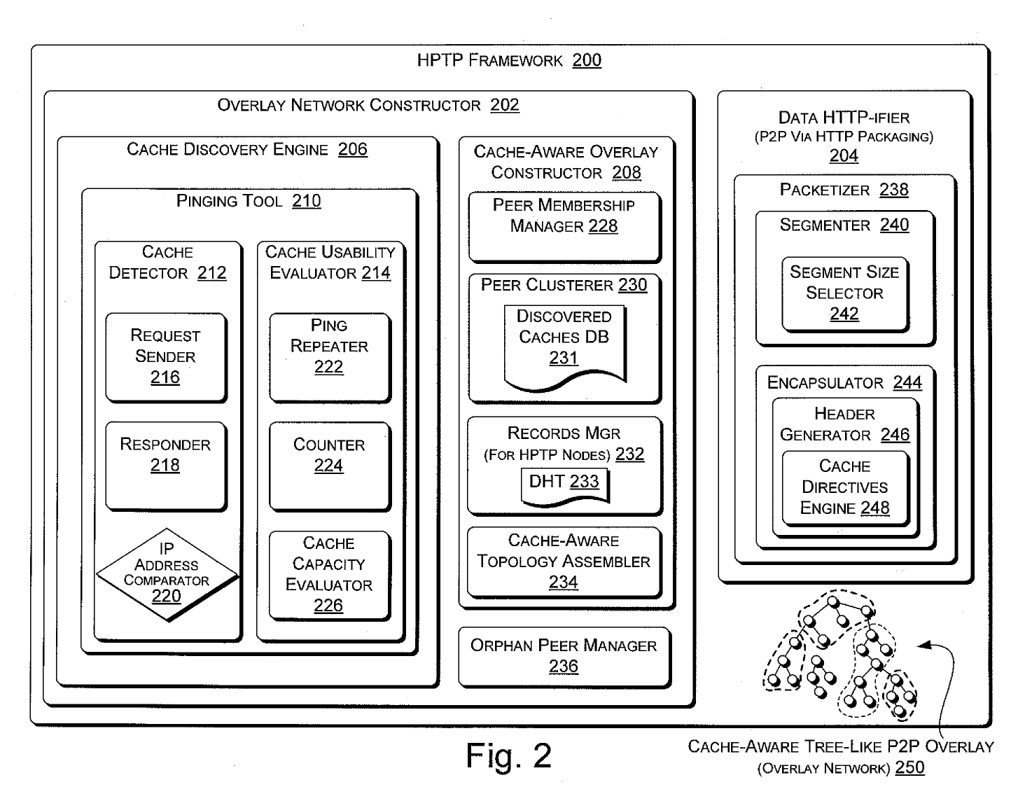

FIG. 2 shows an exemplary HPTP framework 200—that is, a distributed HTTP-based P2P system for allowing P2P traffic to be cached by pre-existing web caches. The illustrated configuration of the exemplary HPTP framework 200 is meant to provide only one example arrangement. Many other arrangements of the illustrated components, or similar components, are possible within the scope of the subject matter. Some components of the exemplary HPTP framework 200 can be executed in hardware, software, or combinations of hardware, software, firmware, etc. It should be noted that the exemplary HPTP framework 200 is a distributed system. Although many of the illustrated components could be gathered together in one computing device (or “node”) on the Internet 100, the HPTP framework 200 is typically spread across nodes that are distributed on the Internet 100.

The exemplary HPTP framework 200 includes an overlay network constructor 202 and a data HTTP-ifier 204—the latter to package P2P data for compatibility with HTTP transport and web cache proxies 108. The overlay network constructor 202 further includes a cache discovery engine 206 and a cache-aware overlay constructor 208. The cache discovery engine 206 includes a pinging tool 210, which includes a cache detector 212 and a cache usability evaluator 214. The illustrated cache detector 212 is outfitted to show both roles of client peer and server peer, with components of each. Thus, the cache detector 212 includes a request sender 216 and a responder 218. The cache detector 212 also includes an IP address comparator 220 that decides whether a cache might be present or not.

The illustrated cache usability evaluator 214 is also outfitted to show both roles of client peer and server peer, with components of each. Accordingly, the cache usability evaluator 214 includes a ping repeater 222 that sends a sequence of same pings (“chained ping”) and at least one counter 224 to increment the number of same pings received from a sender. The cache capacity evaluator 226 includes logic to determine the usability and availability of a given cache 108 and does so by comparing the number of pings sent over a path that has an intervening web cache with the number of pings received by a peer on the other end of the same path.

In one implementation, the cache-aware overlay constructor 208 builds the logical tree-structured P2P overlay 250 that will be cognizant of web caches that intervene between various peer nodes. The cache-aware P2P overlay prefers to deliver the P2P traffic via cached data paths. The illustrated overlay constructor 208 includes a peer membership manager 228 to enumerate and administer the peers that are in the collection of peers for which the P2P overlay is being created. The peer membership manager 228 may also inform the cache discovery engine 206 of the scope of the peer collection for purposes of pinging for cache detection and cache usability. Thus, the peer membership manager 228 designates and tracks the initial overall cluster of peers and the initial cluster head—from which an exemplary cache-aware tree construction protocol begins building the exemplary P2P overlay (as described in greater detail, further below).

A peer clusterer 230 in the overlay constructor 208 may include or have access to a database (list, or some other record) of discovered caches 231 (and their addresses) that are associated with the data paths of the peer membership group—i.e., that intervene between peers in the initial cluster. The peer clusterer 230 groups the HPTP nodes in a natural manner according to the detected caches 108 in the discovered caches database 231.

The peers (HPTP nodes-in-the-making) report their pinging results and their own IP addresses to the records manager 232, and remove their records from storage at a previous node. The records manager 232 may use or comprise a new DHT node for each cluster and may save information about peers that are covered by the same cache 108, in a DHT 233. But the DHT 233 is not essential. Alternatively, a server may be used to save this information. Likewise, other DHT services such as OPENDHT (e.g., that runs on PLANETLAB) may be used. So, the HPTP nodes can be participants of DHT, but they are not required to be.

The peer clusterer 230 appoints a peer 104 whose IP address is the closest to the existing cluster head, as the new cluster head (through IP matching) and informs all peers in the same cluster. The peer clusterer 230 recursively applies the exemplary pinging and clustering techniques until there are no further new and usable caches 108 to be found.

A cache-aware topology assembler 234 constructs the larger, more comprehensive tree structure of the cache-aware tree-like P2P overlay 250 recursively, in a reverse order, starting from the finest clusters. Peers in the same cluster form a subtree by directly connecting to the cluster head. This step is repeated until all the peers are recruited into the P2P overlay 250.

Those peers that fail to discover a new usable cache 108 remain at their previous cluster(s). The orphan peer manager 236 can manage these leftover nodes as an orphan set, that may be built into an orphan cluster or a tree using conventional P2P overlay techniques, or, the orphan peer manager 236 can leave the orphan set to simply use conventional P2P communication. That is, in case of a large orphan set, the orphan peer manager 236 may build a tree out of the cluster using conventional P2P tree building logic, but use HPTP transport strategy, such as naive HPTP (described below), for its data communications. But peers in the orphan set do not need to be a tree. They can resort to any popular P2P technologies, e.g., tree-based architecture for streaming or gossip-based architecture for file downloading.

In other implementations, a server can perform the tree construction functions. When a DHT 233 is used for each cluster associated with a cache, then administration of arriving and departing nodes, with respect to the whole tree, is made somewhat easy. This will be described further below, when the tree construction components are described in greater detail.

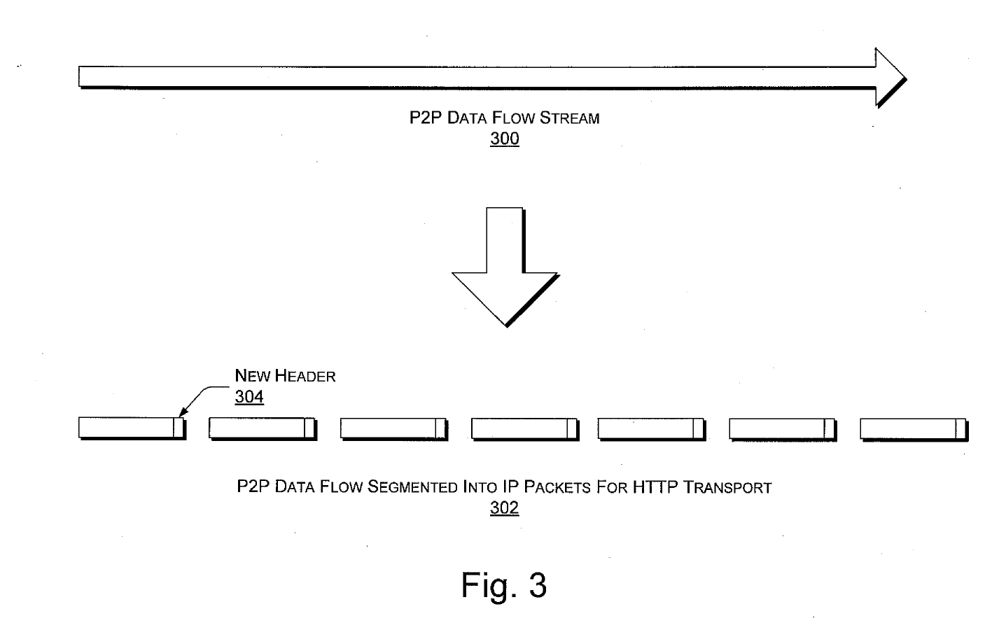

Referring to FIG. 3 and still to FIG. 2, in order to make P2P data 300 amenable to HTTP transport and pre-existing HTTP web caching, the data HTTP-ifier 204 includes a packetizer 238. The packetizer 238 further includes a segmenter 240 that has a segment size selector 242. The packets 302 synthesized from the P2P data 300 for HTTP transport usually have to be within a certain size range to be eligible for induction into a web cache 108. The packetizer 238 also includes an encapsulator 244 with a header generator 246, which further includes a cache directives engine 248. The header generator 246 creates an IP header 304 for each of the newly segmented proto-packets, while the cache directives engine 248 places cache control information into the IP headers so that the packets 302 will be recognized and accepted by the web caches 108.

The cache-aware P2P tree 250 created by the overlay network constructor 202 is a structured arrangement of logic, e.g., including a DHT, that controls the routing of P2P requests so that the requests traverse a web cache whenever possible. This gives the web caches a chance to respond with their own previously cached response rather than query the intended peer, causing traffic.

Operation of the Exemplary HPTP Framework

Regarding the data HTTP-ifier 204, the reason for segmenting the original P2P file is threefold: 1) to make the P2P data cacheable since most web caches impose constraints on the size of cacheable objects; 2) to allow partial caching and fine cache replacement, which has proven to be crucial with certain cache replacement schemes; and 3) to exploit the potential to solicit content from multiple senders as in the BITTORRENT platform.

Thus, the data HTTP-ifier 204 enables a key difference between HPTP and conventional P2P caching proposals—that by converting the P2P traffic to HTTP-able traffic, the exemplary HPTP framework can utilize the existing web cache 108 infrastructure deployed by ISPs 102. The efficacy of HPTP depends on how successfully the web cache proxies 108 can be recruited to cache the HTTP-ified P2P traffic.

HTTP-ifying may incur some overhead. The overhead typically equals the size of HTTP wrapper divided by the segment size. If the segment size selector 242 sets the segment size to 256 kB, then the overhead is less than 1%.

Exemplary Pinging Tool

To increase the cache 108 hit rate, an exemplary cache-aware P2P overlay construction protocol is used. However, unlike conventional P2P applications where peers' addresses are known, most caching proxies 108 are invisible and unknown (especially those deployed by ISPs 102, which are transparent caches). This gives rise to the exemplary pinging tool 210 to detect the caches 108 in the first place. In one implementation, the exemplary pinging tool 210 is a lightweight cache detection tool (in one implementation called “H-Ping”). Experiments and simulations have demonstrated the effectiveness of the exemplary pinging tool 210 for cache detection and cache usability testing.

To describe the function of the exemplary pinging tool 210 in greater detail, a conventional caching proxy (or conventional cache, for short) usually intercepts the TCP connection of a web request and splits it into two separate TCP connections, one to the client (requester) and the other to the server (responder). The logic behind this known design is to always perform cache checking first before attempting to make a connection to the server. The latter connection will be established only if a cache miss occurs. This technique leads to shorter response latency and reduces the traffic to the server.

Upon receiving a request, the conventional cache engine must quickly determine if it still stores the response. This requires the response to be uniquely indexed with information derived from its request and requires that the lookup be performed efficiently. The unique indexing is typically achieved by indexing the response using its uniform resource locator (URL), which is intrinsically unique. Efficient lookup is achieved through hashing.

The network host address in a URL can be expressed using hostnames or IPs (IP addresses), and more interestingly, in an HTTP session, up to three network host addresses may be specified. It is possible to determine if the hostname and IP are interchangeable and which network host addresses are used in the cache's indexing scheme. Experiments on CISCO, MICROSOFT ISAS, and SQUIID caching proxies determine that hostnames and IP addresses are considered different in indexing a response; the response is indexed with preference for “Hostname get”, “Hostname host”, and “Hostname con”. In one implementation, Hostname_con is mandatory, while the other two hostnames are optional. In one implementation, a suitable test message from the exemplary pinging tool 210 is:

telnet Hostname_con 80
GET Hostname_get/helloworld.html http/1.1
HOST Hostname_host

Many different factors can affect the cacheability of a particular response, and these factors interact in a complicated manner. In general, for a response to be cacheable, the size of the object to be cached has to be suitable and certain cache control directives have to be properly set in both the request and the response.

Finally, because caching proxies 108 are shared among many users, they are essential services for ISPs 102 and many organizations (e.g., corporations and universities). As a result, the web caches 108 are typically deployed at strategic points, such as near the organization's network gateways or near the ISP's Point of Presence (POP) in different locations.

Optimal cache placement is a theoretical problem that has attracted in-depth study and is worth further research in a P2P setting. However, because the exemplary HPTP framework 200 exploits web caches 108 that are already deployed, the cache discovery engine 206 “merely” wants to discover where such caches are already deployed—not find out where they should be placed. Moreover, besides discovering the existence of caches, the pinging tool 210 also determines the usability of the discovered caches 108 (i.e., how likely the cache 108 will process the HPTP traffic). Cache Detector of the Pinging Tool

The pinging tool 210 performs cache detection based on the fact that a caching proxy 108 splits a web request into two separate TCP connections, one to the client peer and the other to the server peer. This fact implies that the source IP address that the server sees from the request will be different from the original source IP address (the IP address of the requesting client) if there exists a cache 108 that intervenes in-between the client and server. Therefore, the cache detector 212 determines the existence of the cache 108 by comparing the original source IP address against the source IP address seen by the server. In one implementation, the cache detector 212 includes two modules: a request sender 216 (client module) and a responder 218 (server module)—i.e., a daemon.

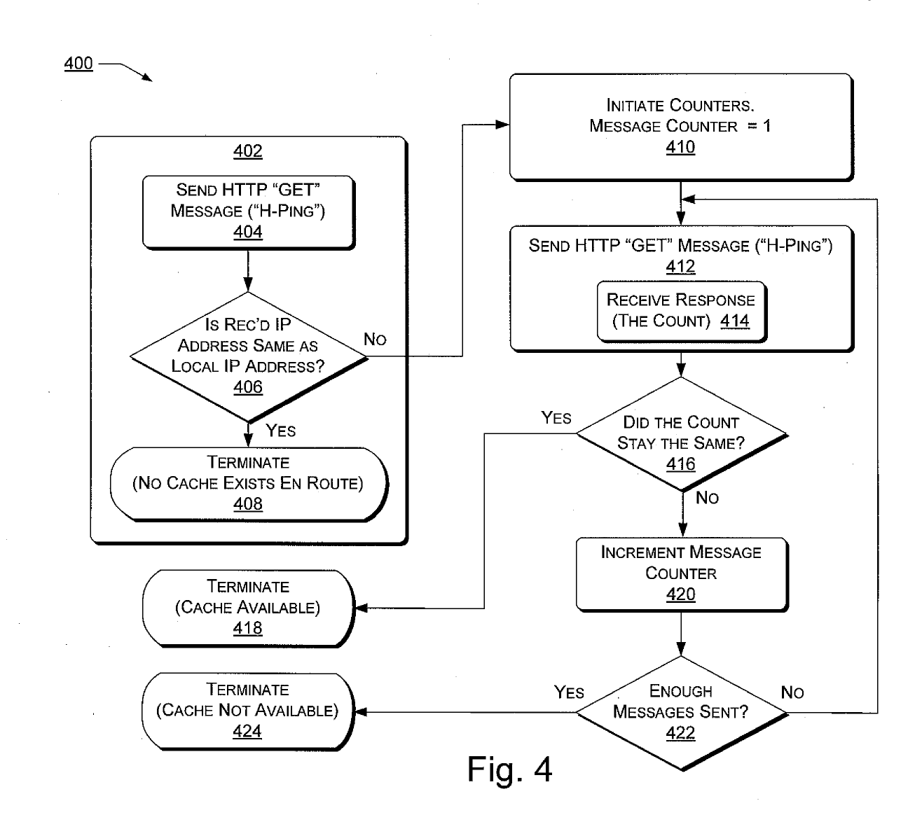

FIG. 4 shows an overall process of this exemplary pinging 400. Let Peer A (P_{A}) and Peer B (P_{B}) denote the pinging peer and the peer being pinged, respectively. During cache discovery (represented by the blocks inside block 402), the request sender 216 of P_{A} first sends (404) an HTTP GET request message to peer P_{B} (the GET request message is referred to as an H-Ping message hereafter). If the H-Ping message is the first time P_{B} receives the request, then the responder 218 of peer P_{B} creates a counter (initialized to “1”) for the new unique request and responds with a cache-friendly HTTP response, the contents of which include requestor's IP address as observed by P_{B}. Otherwise, if this is not the first time that P_{B} has received this unique request, then P_{B} increments the counter that P_{B} has associated with that unique request and P_{B}'s responder 218 sends back only the counter's current count. At block 406, the IP address comparator 220 of peer P_{A} compares the IP address returned from P_{B} with its own IP address. If the two IP addresses are the same, then P_{A}'s IP address comparator 220 concludes 408 that there is no cache 108 between the two peers; otherwise, a cache 108 exists and its IP address is also known.

Note that cache detection 402 may lead to a possible false positive conclusion for the case where network address translation (NAT) or network address protocol translation (NAPT) is in use. In such cases, there may actually be no cache 108 in between the two peers, but the cache detection 402 with the H-Ping message concludes that a cache 108 intervenes, because the IP address seen by the server is actually the client's NAT'ed (external) IP address and thus differs from the client's own (internal) IP address. Fortunately, such a false positive conclusion does detriment the overall pinging process 400 and cache discovery 402 (except a possible waste of sending few H-Ping messages) because the nonexisting, falsely discovered cache is doomed to not pass the subsequent cache usability testing. Incidentally, for many organizational networks, caching proxies 108 are deployed on a gateway, which implies that the corresponding false positives are actually correct.

One seeming limitation of the cache discovery process 402, is that at first glance it can only discern the one cache 108 closest to the responding peer P_{B} even if there are multiple caches 108 in the data path from peer P_{A} to peer P_{B}. Nonetheless, the overlay network constructor 202 can progressively refine the locations of caches 108 by recursively applying the cache detection logic 402, as performed by the cache-aware overlay constructor 208.

Cache Usability Evaluator

In FIG. 4, the blocks of the flow diagram that are not included inside cache discovery block 402 depict client-side cache usability evaluation performed by the cache usability evaluator 214. In one implementation, the pinging tool 210 performs the cache usability testing using chained H-Ping messages. The message chain is formed by sending a number “K” of subsequent identical H-Ping messages. Still using P_{A} and P_{B} as examples, at block 410 the cache usability evaluator 214 of P_{A} initializes one or more local counters, including a counter 224 for sent H-Ping messages. At block 412, the ping repeater 222 of P_{A} issues up to K of the same H-Ping messages, one by one, immediately after the response to a previous request is received back and processed (at block 414). The cache detector 212 may also optionally measure the round trip time, which in some implementations may be useful when constructing the cache-aware P2P delivery tree.

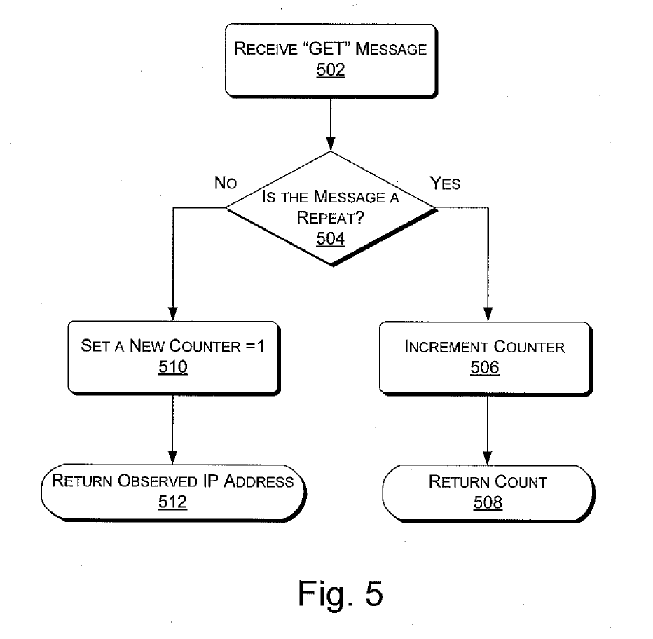

As described above, at the server-side, i.e., peer P_{B}, during cache discovery 402 P_{B} has already associated a counter with each unique request. FIG. 5 shows the process at the responder 218 of peer P_{B}. At block 502, the H-Ping message is received. At block 504, P_{B}'s responder 218 determines whether the H-Ping is a repeated message. If yes, then at block 506 the responder 218 increments the associated counter (e.g., increments request number counter: ReqNum++) for each repeated request and at block 508 includes this count in P_{B}'s cache-friendly response to P_{A}. Incidentally, if the unique request is being received for the first time, then at block 510, P_{B}'s responder 218 associates a new counter with the request, sets the new counter to “1”, and at block 512 returns the observed IP address to P_{A}.

Referring back to FIG. 4, at block 414, P_{A} receives the response and at block 416 the cache capacity evaluator 226 tests if the received count (e.g., ReqNum “request number”) has increased. At this point, peer P_{A} can differentiate a usable cache 108 from a mere NAT table or NATP address change, based on the comparison results. For example, if the count received from P,₃ does not change, then a cache 108 exists between P_{A} and P_{B} (i.e., not a false positive case). This is because the cache 108 keeps returning the previously cached response—with its non-incremented count—instead of the intended peer P_{B} returning the response, in which case the count would be incremented. Then at block 418 the cache usability evaluator 214 terminates the procedure with the conclusion that the cache 108 is immediately useable. If at block 416 the cache capacity evaluator 226 determines that the received count has increased, then at block 420 the counter 224 increments the number of H-Ping messages sent. At block 422, if the number of messages sent equals K, the procedure terminates with the conclusion that the cache is not available (at block 424). If at block 422 the number of H-Ping messages sent does not equal K yet, then procedure loops back to block 412, where the ping repeater 222 sends the next ping in the sequence to P_{B}. If all K H-Ping messages are sent but no conclusion can be drawn, then the cache usability evaluator 214 concludes that the cache in-between P_{A} and P_{B} is not immediate usable (e.g., running out of capacity or a false positive case caused by NAT/NAPT in use).

In one implementation of the exemplary pinging 400, K can be a system parameter related to the available caching capacity and also to the cache replacement policy. Sometimes, there may not be a good estimation for K. In such cases, the cache usability evaluator 214 intuitively sets an initially large K and dynamically reduces K by examining a characteristic of the returned count, such as increment speed and/or increment steps in the returned count. This rationale lies in that fact that the incremental speed of change in the count gives a hint as to how many other peers are performing the probing concurrently, i.e., the “Request Number” count is an indicator of popularity. Moreover, in sending H-Ping messages, the requests from different peers are not differentiate. Therefore, all peers in a group may be performing the cache detection 402 and usability test collectively. This can yield an accurate estimation if the user-base is large.

Exemplary Cache-Aware Tree Constructor (CATC)

In a naïve case, an implementation of the overlay network constructor 202 could simply let a source peer HTTP-ify P2P data and ask all peers to make requests for the data from the source directly, using HTTP transport. Such exemplary “naïve HPTP” is similar to HTTP tunneling except that the traffic is deliberately made cacheable via the HTTP-ifying. However, this provides a passive and best effort leverage of caches 108.

In naïve HPTP, the extent to which the caches 108 are utilized depends on the (geographical) distribution of peers and caches 108. Nevertheless, naïve HPTP is still beneficial because the caches 108 are usually strategically deployed. Another drawback of this naïve scheme, however, is that the source may risk heavy burden and become a performance bottleneck since there is no guarantee on the cache hit rate. Yet one merit of the naïve scheme is that it can be trivially adopted by popular P2P applications such as BITTORRENT for possible best-effort leverage of caches. That is, the naïve scheme is not necessarily limited to the implementation that includes building a tree structure. Other gossip-based structures are also eligible.

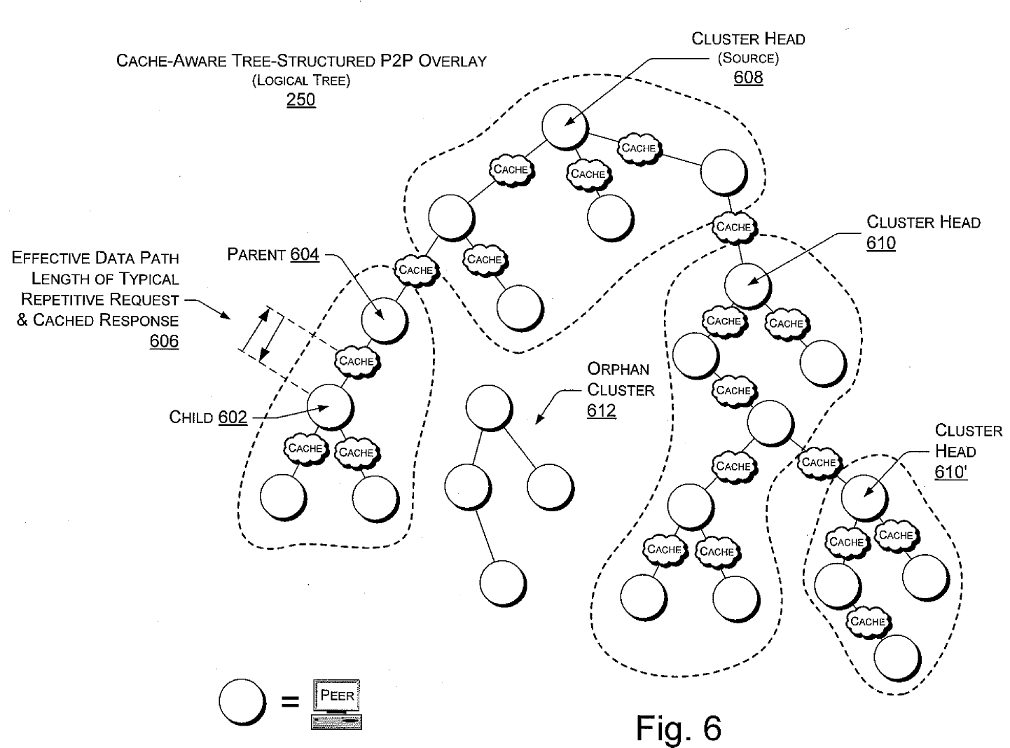

FIG. 6 shows an example of the cache-aware tree-structured P2P overlay 250. To avoid the aforementioned performance bottleneck that can occur when naïve HPTP is used, the cache-aware overlay constructor 208 builds the cache-aware delivery tree 250 with explicit control of selection of the web caches 108. This is achieved via an exemplary cache-aware tree construction (CATC) protocol described below. As shown in FIG. 6, once the exemplary overlay tree 250 is built, each peer (e.g., 602) only requests data from its parent 604, instead of the single source peer, as in the naïve HPTP case. For example, for a typical repetitive request, the scope 606 of the request/response sequence it just the data path to the intervening cache and back. The data path between a given child node 602 and its parent node 604 may not always be the shortest route in a physical sense or even in a non-cached IP transport sense. However, the data path between child 602 and parent 604 is usually the shortest logical route that includes an intervening cache 108. Hence, when the cache hit rate is high or even just satisfactory, the effective data path for requests with repetitive cached responses is much shorter than traversing large round trip distances over conventional P2P network paths, and in addition prevents the P2P traffic from congesting the ISP 102, since the caches 108 short circuit requests for redundant data.

Exemplary Cache-Aware Tree Construction (CATC) Protocol

In one implementation, the cache-aware overlay constructor 208 regards a group of peers 104 and a source peer as in a large cluster at the beginning of the construction process, with the source being the cluster head 608. Then in one implementation, the overlay constructor 208 performs the following five steps.

1. The cache detectors 212 and cache usability evaluators 214 of all peers in the same cluster perform cache detection and cache usability testing against the cluster head 608, and record (in stack order) the head information locally.

2. All peers report their results and own IP addresses to the records manager 232 (e.g., to a new DHT node where the DHT 233 is used for storing the information about peers that are covered by the same cache 108), and remove their records from the previous one. The peer clusterer 230 further clusters the HPTP nodes in a natural manner according to the detected caches 108 in the discovered caches database 231. Those peers that fail to discover a new usable cache 108 remain at their previous cluster(s) and form an orphan set that may be built into an orphan cluster 612 using conventional P2P overlay techniques, or may remain as a group that simply uses conventional P2P communication.

3. The DHT nodes appoint a peer 104 whose IP address is the closest to the source 608, as the new cluster head 610 (through IP matching) and inform all peers in the same cluster. (For peers behind NAT/NAPT, external IP addresses are required.)

4. The steps above are recursively applied until there are no further new and usable caches 108 that can be found.

5. Finally, the cache-aware topology assembler 234 constructs the cache-aware tree-structured P2P overlay 250 recursively in a reverse order, starting from the finest clusters. Peers in the same cluster form a subtree by directly connecting to the cluster head. This step is repeated until all the peers are recruited into the tree 250. In case of a large orphan set 612, the orphan peer manager 236 may optionally build a tree (612) out of the cluster using normal P2P tree building logic, but use HPTP transport strategy for its data communications.

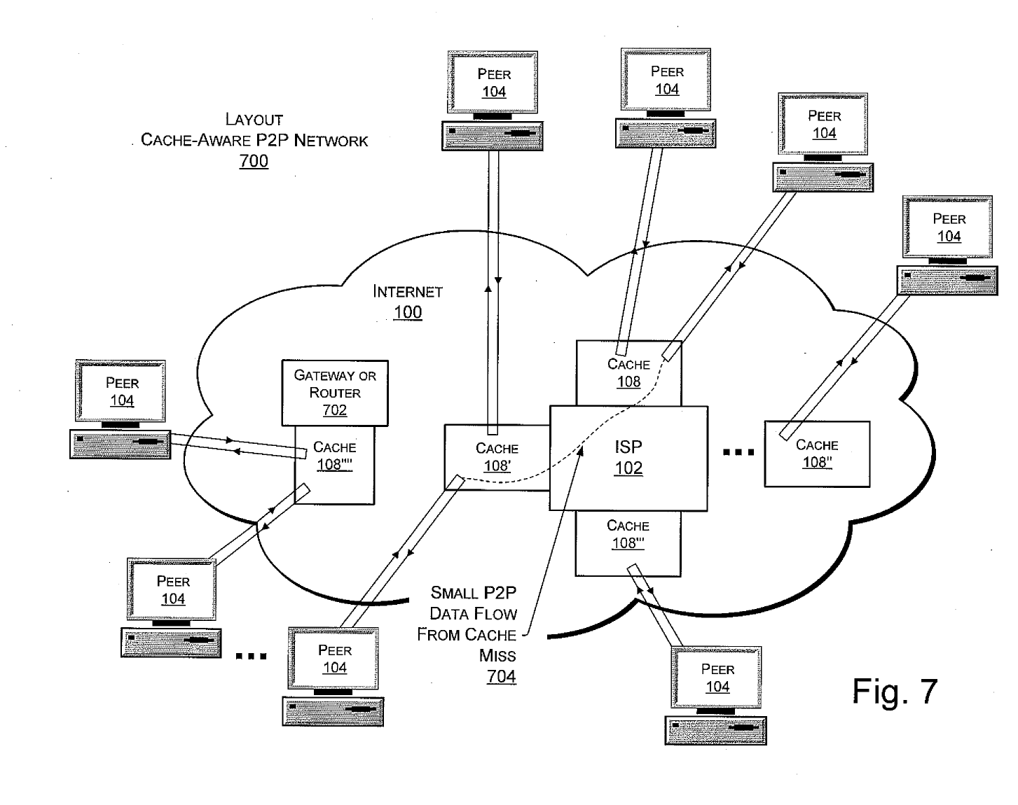

FIG. 7 shows an exemplary layout 700 of a HTTP-based cache-aware P2P network, in which the P2P communication is HTTP-ified and controlled by the logical structure of the exemplary cache-aware tree-structured P2P overlay 250 of FIG. 6. The cache-aware tree-structured P2P overlay 250 incorporates caches 108 into the logical structure of the tree 250 when the caches 108 are in a relevant intervening data path. The pre-existing strategic placement of each cache 108 is also an automatic free benefit in the exemplary tree construction protocol: caches 108 are often associated with ISPs 102, or are stationed in association with gateways 702, transit routers, etc. For the sake of description, an almost perfect cache hit rate of near 100% is illustrated with only a small P2P data flow 704 shown from cache misses between two of the peers.

The implementation just described uses a DHT to organize the collected cache information. Alternatively, a server can be used for this purpose. However, DHT naturally helps to cluster the peers since peers reporting to the same DHT nodes are covered by the same caching proxy. This avoids an explicit clustering process as would be the case if a server were used. Also, using DHT is a more robust and scalable way to collect the cache information for a longer time period. But DHT is not the only way. It is also possible for the peers to not participate in DHT at all, i.e., it is possible to leverage other DHT services. It is also possible that only some of peers form a DHT overlay.

Handling peer dynamics is typically an obstacle in conventional P2P system designs. However, peer dynamics handling in the exemplary HPTP framework 200 is much easier because the caches 108 recruited into the cache-aware overlay tree 250 can be thought of as “giant peers”: powerful, reliable, dedicated, and strategically deployed. Their existences help to hide away peer dynamics problems, besides boosting delivery performance, as now described.

With regard to departing peer nodes or node failures, the exemplary HPTP framework 200 keeps silent as much as possible to peer departure or failure. If leaf nodes leave the tree 250, there is no impact at all. If some intermediate nodes of the tree 250 (i.e., those who have been HPing'ed) leave the system, there is no change to children peers at all (because the content may have been cached already and the cache 108 can help) unless the children peers receive a “connection refused” error message (indicating the content is not cached). In this case, the children peers can react by simply popping up another peer from their local stacks—that have been built during the cache-aware tree construction process.

With regard to peer joining, newly joined peers always follow the exemplary CATC procedure orchestrated by the overlay constructor 208 to reach the finest cluster. When no new useful cache can be found, the new peer adds itself to the orphan set 612 at the corresponding level and directly connects to the last successfully HPing'ed peer. One interesting artifact is that even if an intermediate node has actually left the system when a later peer joins, it is still possible for that peer to reach a finer subtree of that intermediate node, as long as its response to HPing is still cached. Peers in orphan set 612 may periodically perform a peer joining procedure in case there are caches 108 warmed up after their usability test.

The robustness of the cache-aware tree-structured P2P overlay 250 to these peer dynamics is a direct result of the design logic of web caching proxies 108: that is, to always perform cache checking first before attempting to make connections. This property of caching proxies also makes the maintenance of the cache-aware tree-structured P2P overlay 250 very simple. Unlike other tree maintenance protocols, no heartbeat message is needed to test the aliveness of the peers. Similarly, there is no need to perform periodic optimization for the cache-aware P2P tree 250. Instead, only peers experiencing low performance may perform opportunistic optimization by rejoining the tree 250.

Exemplary Methods

FIGS. 4 and 5, previously discussed, show exemplary pinging methods, for detecting pre-existing web caches that perform HTTP transport and for determining usability of the detected web caches.

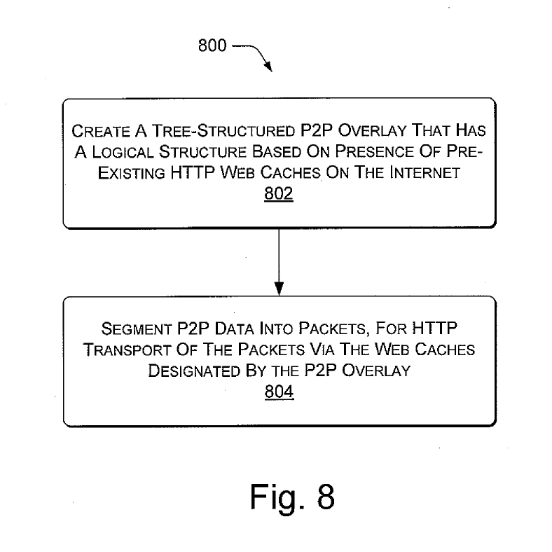

FIG. 8 shows an exemplary method 800 of reducing peer-to-peer (P2P) congestion for Internet Service Providers. In the flow diagram, the operations are summarized in individual blocks. Parts of the exemplary method 800 may be performed by hardware, software, firmware, etc., or combinations thereof, for example, by components of the exemplary HPTP framework 200.

At block 802, a P2P overlay tree is created that has a logical structure based on presence of pre-existing Internet web caches. An ancillary pinging method first finds the existence of pre-existing web caches (pre-existing for HTTP traffic) on the Internet, that is, web caches that could potentially intervene between P2P peers. Such web caches are generally transparent to usual data communications and so the ancillary pinging method uses an exemplary IP address reflection/echoing technique to sense the existence of the invisible web caches by IP address comparison. An associated pinging technique uses an exemplary ping-counting process to further establish the usability of discovered web caches. The ping-counting process also differentiates the web caches from NAT/NATP processes that mimic web caches in changing IP addresses between sender and receiver.

Once the pre-existing web caches are discovered and found usable, a logical overlay tree that encourages data transit through the web caches is constructed, such that requests from any given peer are only sent to the parent node of the sending peer. Since web caches ubiquitously intervene between nodes of the exemplary cache aware P2P tree according to its exemplary design, a great number of requests for redundant data never even make it to the nearest parent node, but are serviced by the intervening cache, thus sparing the ISP from congestive P2P traffic.

At block 804, P2P data are segmented into IP packets for HTTP transport of the packets via pre-existing Internet web caches, designated by the overlay tree. In order for the cache-aware tree-structured P2P overlay to work, the P2P data is HTTP-ified by packetizing the data in suitably sized segments that can be stored at the web caches, and encapsulating these P2P data segments with an IP header that contains cache-friendly cache control directives. Then, the pre-existing web caches handle and cache the P2P traffic just like any other sequence of IP packets.

### CONCLUSION

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method, comprising:
segmenting P2P data into packets for HTTP transport;
transferring the packets via the HTTP transport;
wherein the packets are cached when the transferring uses a data path that includes one or more caches for HTTP transported packets.

2. The method as recited in claim 1, wherein the caches comprise pre-existing web cache proxies for caching HTTP data traffic on the Internet.

3. The method as recited in claim 1, further comprising creating a cache-aware P2P overlay to deliver the packets via data paths that include the caches.

4. The method as recited in claim 3, wherein creating the cache-aware P2P overlay includes:
representing peers as nodes of the overlay; and
clustering groups of the nodes according to an association with one of the caches.

5. The method as recited in claim 1, further comprising discovering the caches via pinging between peers, wherein the pinging comprises:
sending a request from a first peer possessing a first IP address to a second peer;
sending a response from the second peer to the first peer, wherein the response includes a second IP address associated with the received request;
comparing the second IP address from the response with the first IP address of the first peer;
when the first and second IP addresses match, determining that no cache intervenes between the first peer and the second peer; and
when the first and second IP address do not match, determining that a cache or a network address translation (NAT) table intervenes between the first peer and the second peer.

6. The method as recited in claim 3, wherein a tree-like structure of the P2P overlay self-maintains during peer dynamics using the cache-aware structure of the P2P overlay.

7. The method as recited in claim 6,.wherein the peer dynamics include:
departing or failing peer nodes, wherein departing leaf nodes of the tree-like structure have no impact on the P2P overlay, departing intermediate nodes have no impact on their children nodes of the P2P overlay due to the cache-aware structure, and children nodes denied a connection can generate another peer from their local stacks that have been built during the creating of the cache-aware P2P overlay;
peer joining, wherein newly joined peers reach a finest cluster of the P2P overlay and when no cache can be found, each new peer adds itself to an orphan set at a corresponding level of the P2P overlay and directly connects to the last successfully discovered peer; and
wherein the P2P overlay does not require periodic optimization.

8. The method as recited in claim 5, further comprising applying a cache usability evaluation to each cache, including:
repeatedly pinging from a first peer to a second peer;
returning a count of pings received at the second peer; and
if the count does not change in relation to the number of pings sent by the first peer, then determining that an intervening cache between the first peer and the second peer is usable in creating the cache-aware P2P overlay.

9. The method as recited in claim 3, further comprising creating a P2P structure consisting of peers not associated with a cache.

10. The method as recited in claim 1, wherein the segmenting P2P data into packets for HTTP includes selecting a data segment size that allows the packets to be cached by a web cache proxy.

11. The method as recited in claim 1, wherein the segmenting further includes encapsulating P2P data segments with a packet header.

12. The method as recited in claim 11, wherein the encapsulating further comprises including cache control directives in each packet header.

13. The method as recited in claim 3, wherein creating the P2P overlay includes creating structured overlay tree logic for linking nodes of the P2P overlay, such that the logic linking two of the nodes is based on a presence of at least one usable cache between two peers that the two nodes represent and such that each node only requests data from an adjacent parent node in the P2P overlay.

14. A system, comprising:
computers coupled with the Internet; and
an HTTP-based P2P framework for caching P2P traffic between the computers using pre-existing Internet web caches.

15. The system as recited in claim 14, wherein the HTTP-based P2P framework includes a segmenter to packetize P2P data for HTTP transport.

16. The system as recited in claim 15, wherein the HTTP-based P2P framework includes an overlay tree constructor to form a cache-aware tree-structured P2P overlay;
wherein the cache-aware tree-structured P2P overlay directs P2P communications along data paths between peer nodes of the P2P overlay that have an intervening web cache for HTTP traffic; and
wherein the data paths reduce P2P traffic by maximizing cache hits of P2P requests.

17. The system as recited in claim 16, further comprising a cache discovery engine to ping between peers sending the P2P traffic;
wherein a receiving peer responds to a ping from a sending peer with a message containing an IP address of the incoming ping;
wherein the sending peer compares the IP address in the message with its own IP address; and
wherein a mismatch of the IP addresses indicates an intervening web cache between the two peers.

18. The system as recited in claim 17, wherein the cache discovery engine includes a cache usability evaluator to ping repeatedly between two peers that have an intervening web cache and count a number of cached pings to determine a usability of the cache for constructing the P2P overlay tree.

19. The system as recited in claim 16, further comprising a distributed hash table (DHT) node or a server to construct the cache-aware tree-structured P2P overlay by clustering peers according to their association with a web cache proxy.

20. A packetizer, cache discoverer, and cache-aware P2P overlay for caching P2P traffic in pre-existing Internet HTTP caches.
